(19) United States
(12) Patent Application Publication
(10) Pub. No.: US 2006/0036663 A1
(43) Pub. Date: Feb. 16, 2006

(54) Method and apparatus for effective data management of files

(75) Inventor: Moon-sang Kwon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/193,347

(22) Filed: Aug. 1, 2005

(30) Foreign Application Priority Data
Aug. 4, 2004 (KR) 10-2004-0061435

(51) Int. Cl. G06F 17/30

(52) U.S. Cl. 707/206

(57) ABSTRACT

A method and apparatus for effective data management of files are provided. A method for efficient data management of a file includes receiving a request to delete a file, searching for mapping blocks constituting the file in a block map which is constructed with a set of the mapping blocks, the mapping blocks storing therein information about data blocks constituting the file, and adding a linked list to a deletion list, the linked list formed with the mapping blocks obtained as a result of the search.

### CROSS-REFERENCE TO RELATED APPLICATIONS

This application claims priority from Korean Patent Application No. 10-2004-0061435 filed on Aug. 4, 2004, the disclosure of which is incorporated herein in its entirety by reference.

### BACKGROUND OF THE INVENTION

1. Field of the Invention

Apparatuses and methods consistent with the present invention relates to efficient data management of files.

2. Description of the Related Art

A file is a set or collection of data. Generally, the file is stored in a hard disk, a memory card, a compact disk-read only memory (CD-ROM) and the like. The file has various functions to provide information to such systems as a computer, a personal digital assistant (PDA) or a cellular phone, to operate a certain function, or supply information to a user.

A file system provides methods and functions to write, read and use the file. Digital devices (for example, a computer) have a file allocation table (FAT), a new technology file system (NTFS), and/or a high performance file system (HPFS). The file system performs functions to efficiently manage files, and provides rapid search and recovery of data, and support of large-sized data. The file system is mainly focused on decreasing the bottleneck caused to the system due to a storage device having a processing speed which is relatively slower than the CPU, and facilitating the file processing, thereby enhancing performance of the whole system. A large number of digital devices handling digital multimedia use file systems compatible with computers, thereby enabling file exchanges through computers. Currently, many digital devices store multimedia data therein, making use of the file systems.

A conventional file system has concentrated on reading and writing operations of files rather than the speed of deleting them. It was unusual for a file to have a large capacity, and thus, the main focus of the conventional system was to efficiently manage many files.

However, as a file increases in size to have a large capacity, and the file of large capacity is moved or copied in a various manner through portable storage media (e.g., a memory card) rather than computer storage media (e.g., a hard disk), deletion of the file has become the key point in assessing performance of the file system.

FIG. 1A is a block diagram illustrating configurations of a conventional file system and a storage medium. File systems including FAT, HPFS, and NTFS manage files based on block maps. As depicted in FIG. 1A, a hard disk or a memory card is divided into a data block and a block map.

A data block becomes a unit to store data, and the data is stored in a storage space of the hard disk or the memory card on a data block basis. The data block can be a unit such as 512 bytes or 1024 bytes to store data. Data whose size is larger than 512 bytes or 1024 bytes are divided into blocks, depending upon the size of the storage unit, and then stored. In a file system using FAT, a data block is referred to as “a cluster.”

A block map is a collection of information about the data blocks. As seen in FIG. 1A, a block map 100 and a data block 200 may be stored in a storage device. There is a file system 10 to manage mapping between the block map 100 and the data block 200 and files.

Configurations of the block map and the data block are illustrated in FIG. 1B. Each of the blocks 101 and 102 constituting a block map shows a state of the concerned data block. That is, each block has information to identify whether a file is stored in the data block or the data block is available for storage. A file allocation table in the FAT system is an example of the block map. Based on information of the blocks constituting a block map, it is possible to ascertain a state of the concerned data block without directly considering the whole data block. The value of a block in the block map indicates whether a position of next data or a state that data is not stored in the concerned data block. In addition, where the concerned data block, e.g., a cluster is damaged so as not to be available for storing files therein, the block value may indicate whether the cluster is damaged. For the sake of convenience, the block map will be described under the assumption that its address starts from 1, but which is merely an example to embody a file system. The block map addressed #1 identifies information about the data block in the address #1.

Table 1 shows values indicated by blocks of a block map in the FAT system.

TABLE 1

| | FAT 12 | FAT 16 | FAT 32 |
|---|---|---|---|
| Indicate | 000 | 0000 | 00000000 |
| availability | | | |
| Indicate reserved | 001 | 0001 | 00000001 |
| cluster | | | |
| User data | 002-FF6 | 0002-FFF6 | 00000002- |
| | | | 0FFFFFF6 |
| Bad cluster | FF7 | FFF7 | 0FFFFFF7 |
| Indicate | FF8-FFF | FFF8-FFFF | 0FFFFFF8- |
| termination | | | 0FFFFFFF |

The values indicated by these blocks may vary depending upon how the system is embodied. In different file systems such as NTFS or HPFS, the values are indicated according to agreed definitions of the concerned file systems.

These data cannot always be stored sequentially. In the course of deleting or storing a file, available storage spaces may be scattered in a storage medium. The block map identifies positions of the blocks in a linked list so as to read out data sequentially from several data blocks constituting the file. This mapping is accomplished through blocks of the block map.

Throughout this specification, the blocks constituting a block map will be referred to as mapping blocks.

FIG. 2 illustrates a concept of file storage through a block map in the conventional file system. As described above, the block map 100 has information about a data block which is a unit of storing data in a data area. Data blocks may vary in size (512 bytes, 1024 bytes, etc.) according to file systems.

How a file named file.txt is stored will now be considered. Referring to FIG. 2, the file named file.txt indicates a start position of a mapping block that shows information of the starting data block. Inside the block map 100 is constructed a link whereby mapping blocks indicating data blocks on which this file is stored are sequentially linked. That is, it can be known that the file named file.txt is stored in the data block addressed #3. To read out data from this file, the mapping block addressed #3 should be referenced. For the sake of convenience, blockmap(k) means a mapping block addressed #k, and datablock(k) means a data block addressed #k.

The blockmap(3) has a value of 0004, indicating that the next data constituting this file is stored in the address of #4, that is, datablock(4). Information about this data block addressed #4 is stored in the mapping block addressed #4. Blockmap(4) has a value of 0006, indicating that the next data is stored in the data block addressed #6. In this way, the block map enables data constituting a file to be read out sequentially. In an example of FIG. 2, a file named file.txt is sequentially stored in data blocks of the addresses #3, #4, #6, #7 and #8 by linking the mapping blocks. A value of blockmap(8) is 0xffff, which indicates the termination of the file. The termination of the file may be indicated with a value other than 0xffff. However, to avoid confusion, the value must not overlap with the addresses of the mapping blocks. For example, as confusion is caused if a mapping block with the address of 0xffff exists, thus a larger or different value should be used so as not to overlap with it.

Using a block map-based file system, it is advantageous in that logical mapping is provided although there is no physical mapping, to thereby store data. However, a problem is caused in deleting a file.

A data block available for use in the block map may be indicated with a predetermined value as agreed to in advance, (e.g., 0). When a file is deleted, the whole information of the mapping block including information about the data block on the position which the file is stored should be changed.

When the file named file.txt is deleted in FIG. 2, all the values of mapping blocks of the block map 100 addressed #3, #4, #6, #7 and #8 need to be changed to 0. Such a change may cause no problem when the file is small in size. However, the sizes of files have recently increased to a large capacity owing to development in multimedia technology, and the large-sized files require much more time to process deletion of the file. For example, to delete a file of 30 M bytes having a data block size of 512 bytes, 30M bytes/512 bytes is calculated. As a result, this file has information about 61,440 mapping blocks (that is, 30×1024×1024/512). Accordingly, information regarding 61,440 mapping blocks within the block map must be changed, requiring much processing time. In the case of NAND flash memory sensitive to a write operation, efficiency of this storage device may be degraded because of unnecessary change of block map data of the file system.

Where deletion is suspended because of an error caused in the course of deletion, information about the undeleted mapping blocks may occupy the storage space. This case is illustrated in FIG. 3.

FIG. 3 is a block diagram illustrating how an error caused in deleting a file affects a storage device in the conventional file system.

FIG. 3 shows deletion of a file, file.txt, of FIG. 2. This file.txt has five data blocks. To delete this file, the mapping blocks corresponding to five data blocks should be changed to 0. However, if an error is caused in the course of changing the blockmap(6) to 0, the values of the mapping blocks addressed #6, #7 and #8 remain unchanged and are stored as they are. However, as the file, file.txt, merely indicates the address of #3, it is not ascertained whether change of the mapping block at the address #6 has been suspended and thus unfinished. As a result, the data blocks addressed #6, #7 and #8 are retained as unusable blocks. These blocks do not belong to a specific file, and thus, they cannot be deleted; later they may be deleted through disk defragmentation. But this defragmentation is designed to cover the entire range of a storage medium, and is not always conducted. Further, the fragmentation of the disk requires for a considerable amount of processing time, and for this reason, it cannot frequently be conducted.

The problem illustrated in FIG. 3 may be more frequently caused with respect to files of large capacity. As the number of mapping blocks to be changed increases, the time required for completing the change increases, and the possibility that any error is caused during that time increases accordingly. Taking this into consideration, it is necessary to shorten the possibility that any error is caused in, and the time required for, deleting a file.

Korean Unexamined Patent Publication No. 2002-0087707 discloses a method and an apparatus for indicating block information carried by a concerned bit, using a bitmap. But, since the bitmap indicates information about the block's storage condition, all of the bits need to be changed when deleting them, thereby causing inconvenience.

Especially in digital devices with which moving pictures are frequently photographed, rapid deletion of moving pictures of large capacity and storage of new, different moving pictures influence heavily upon improving speeds of the digital devices.

### SUMMARY OF THE INVENTION

The present invention provides a method and apparatus for efficient data management of a file.

According to an aspect of an exemplary embodiment of the present invention, there is provided a method for data management of a file, comprising: receiving a request to delete a file; searching for mapping blocks constituting the file in a block map which is constructed with a set of the mapping blocks, and the mapping blocks store therein information about data blocks constituting the file; and adding a linked list formed with the mapping blocks obtained as a result of the search, to a deletion list.

According to another aspect of an exemplary embodiment of the present invention, there is provided a method for data management of a file, comprising: receiving a request to allocating file storage space; securing a storage space, using mapping blocks constituting a deletion list in a block map storing therein information about data blocks constituting the file; and removing the mapping blocks used for the storage space from the mapping blocks constituting the deletion list.

According to yet another aspect of an exemplary embodiment of the present invention, there is provided an apparatus for data management of a file, comprising: data blocks in which data of the file are stored; a block map consisting of a set of mapping blocks storing therein information about the data blocks; a deletion list consisting of a set of mapping blocks about the file deleted previously; and a block allocating unit allocating a space for storing the file, using mapping blocks of the deletion list.

### BRIEF DESCRIPTION OF THE DRAWINGS

The above and other aspects of the present invention will become more apparent by describing in detail exemplary embodiments thereof with reference to the attached drawings in which:

FIGS. 1A and 1B are a block diagram illustrating configurations of a conventional file system and a storage medium;

FIG. 2 is a conceptual diagram illustrating storage of a file through a block map in the conventional file system;

FIG. 3 is a block diagram illustrating how an error caused in deleting a file affects a storage device in a conventional file system;

FIG. 4 illustrates configurations of a file system and a storage device according to an exemplary embodiment of the present invention;

FIGS. 5A to 5C is a conceptual diagram illustrating an example of file deletion according to an exemplary embodiment of the present invention;

FIG. 6 is a conceptual diagram illustrating an operation by a block allocating unit to store a file according to an exemplary embodiment of the present invention;

FIGS. 7A and 7 are block diagrams illustrating an example of file deletion according to another embodiment of the present invention;

FIG. 8 is a block diagram illustrating restoration of a deletion list to an available storage space according to an exemplary embodiment of the present invention;

FIG. 9 is a flow chart illustrating deletion of a file according to an exemplary embodiment of the present invention; and

FIG. 10 is a flow chart illustrating storage of a file according to an exemplary embodiment of the present invention.

### DETAILED DESCRIPTION OF EXEMPLARY EMBODIMENTS OF THE INVENTION

A storage medium constituting a computer system includes a file system and data actually stored therein. As described above, the file system refers to a system to effectively manage files. Various file systems are currently used in a number of computer systems, which will be briefly described below.

File Allocation Table (FAT)

A FAT is a file system supported by a WINDOWS™ system, which exists in the form of a file table in a disk. For recovery of the FAT when it is damaged, there are two FATs. This is the simplest form among file systems supported by WINDOWS NT™ system. The FAT is an initial file system, and there are versions of FAT such as FAT12, FAT16 and FAT32. FAT16 can be used under different operating systems, in addition to the WINDOWS™ operating system.

High Performance File System (HPFS)

This file system was introduced in OS/2 1.2, and comprises a directory configuration of the FAT. This system includes a function of automatically arranging files based on file names. This system increases flexibility to naming convention, and decreases loss of a disk by using a unit for file allocation as a physical section in a cluster. The HPFS enables a single file to be stored in a series of linked sectors, thereby speeding up the file system.

New Technology File System (NTFS)

An NTFS manages files on a directory basis, and arranges them like HPFS. This system also provides a function of remedying any error of the file system and preventing deletion of sectors. This system inspects which jobs have been done to a file and cancels the jobs done, thereby maintaining consistency within the file system. This is usually used in the WINDOWS NT™ system, but can be used in the LINUX™ system.

These file systems can be applied to digital devices storing data therein, in addition to computers. Accordingly, they are also applicable to machines and apparatuses handling digital data, including cellular phones, PDAs, notebook computers, digital TVs.

These file systems can also be applied to storage media such as hard disks, compact disks, external storage media such as flash memories, memory stick duos, or secure digital (SD) cards or multimedia cards (MMCs), and so on.

Great interest has recently been given to digital multimedia data, and a file system has become an essential construction in digital machines and apparatuses. A method and an apparatus for deleting and storing files embodied by a file system according to an exemplary embodiment of the present invention can be applied to built-in memories of an apparatus handling digital multimedia information.

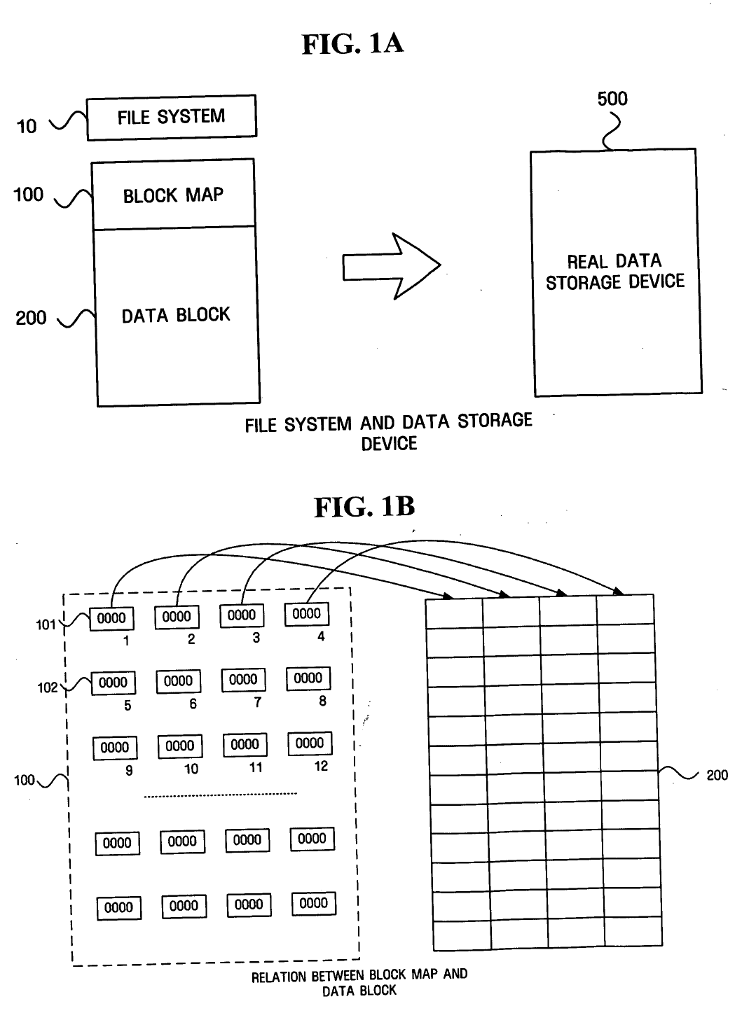

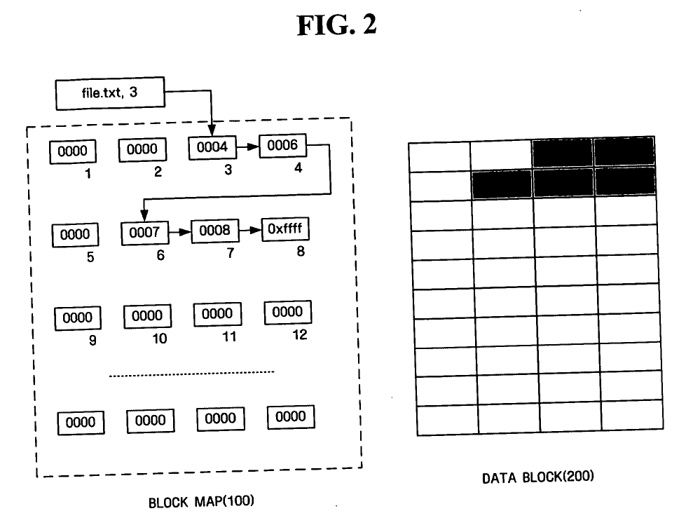

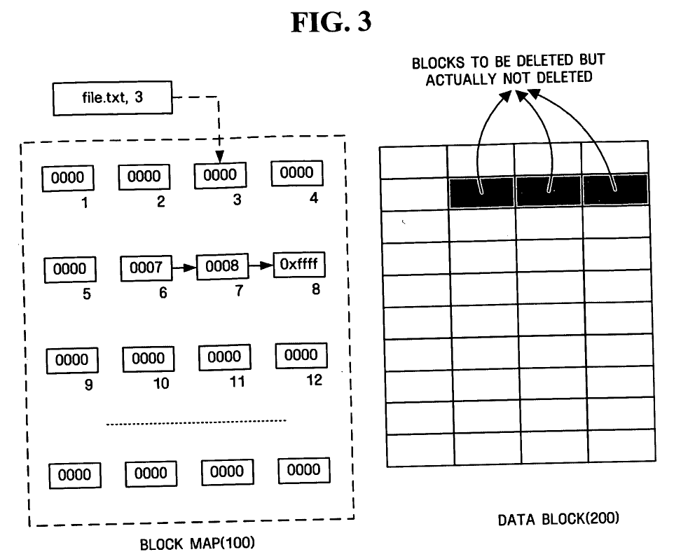

Each file system has inherent properties. Like the file systems described above, most file systems have constructions as illustrated in FIG. 1. That is, they are constructed with block maps having information about a position of each file, and collection of data (bits) constituting the file.

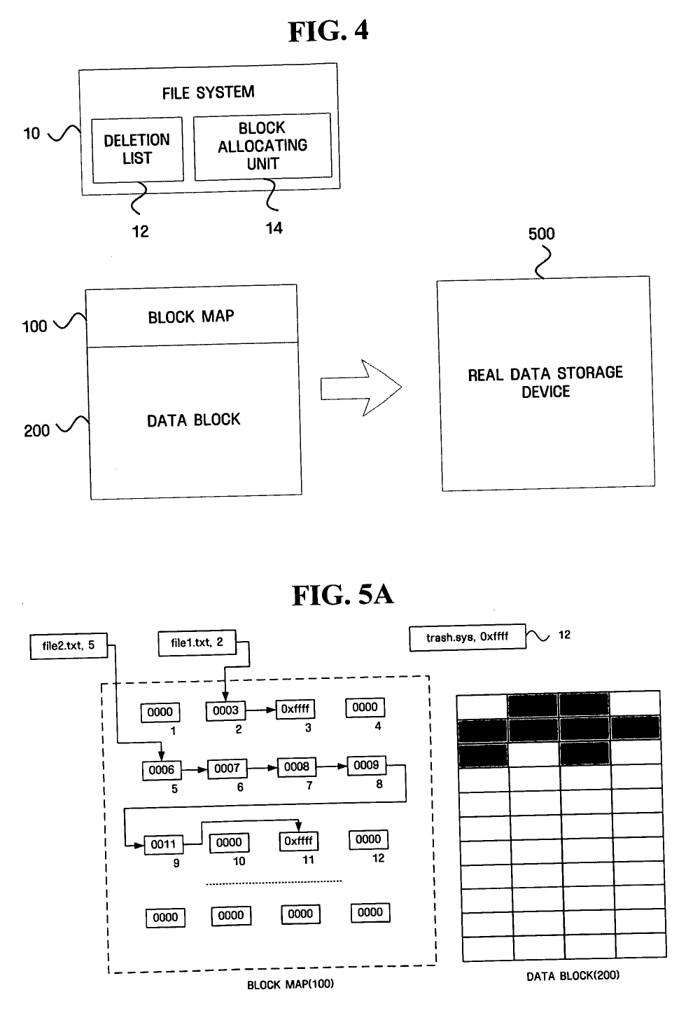

FIG. 4 illustrates configurations of a file system and a storage device according to an exemplary embodiment of the present invention.

In the exemplary embodiments of the present invention to be described below, a “part” or a “module” refers to a software component or a hardware component such as a field-programmable gate array (FPGA) or an application-specific integrated circuit (ASIC). The module performs particular functions but is not restricted to software and hardware. The module may be included in an addressable storage medium or may be configured to play one or more processors. Accordingly, modules may include components such as software components, object-oriented software components, class components, and task components, processes, functions, attributes, procedures, subroutines, segments of a program code, drivers, firmware, microcodes, circuits, data, databases, data structures, tables, arrays, and parameters. Components and features provided by modules may be combined into a smaller number of components and a smaller number of modules, or may be divided into a greater number of components and a greater number of modules. In addition, components and modules may be implemented such that they play one or more central processing units (CPUs) in a device or a secure MMC.

The file system 10 comprises a deletion list 12 and a block allocating unit 14. The deletion list 12 manages a list of mapping blocks of deleted files. When a file is deleted, mapping blocks constituting the file are linked to the deletion list 12, and the deletion list 12 does not change the mapping blocks to 0. The deletion list 12 may be constructed with a file format (i.e., trash.sys) or as a specific value within the file system 10. The deletion list may be embodied diversely depending upon the file systems. When no file is deleted, the deletion list 12 may not be created. For example, there would be no deletion list 12 when the deletion list 12 is embodied in the form of a file. If this is the case, a new deletion list 12 may be created when the file system is installed. When a request for deletion of a file is inputted but no deletion list 12 exists in the file system, the file may be converted into a deletion list 12 or a new deletion list is created so as to perform the deletion of a file.

The block allocating unit 14 searches for any available storage space to store a file therein. In the conventional art, an available storage space is recognized through the specific value of a mapping block (e.g., 0). Unlike the conventional art, a mapping block having the value of 0 may be searched in a block map or mapping blocks constituting the deletion list may be used.

When using the mapping blocks, there is no need to search for a mapping block having the value of 0 in the block map so as to locate an available storage space; in lieu thereof, a file is stored using the deletion list.

Accordingly, when using a deletion list, any change of the mapping blocks due to deletion can be avoided, and operations to change the block map to create a linked list for mapping blocks may be reduced in storing the file. This is especially useful for a storage medium such as a NAND flash memory, sensitive to a write operation. Further, where data is allocated to the deletion list, the time to conduct necessary operations to create a new map may be shortened because a link (chain, connection) of mapping blocks already constructed is used.

The deletion list may have a start address of a linked list formed by the deleted mapping blocks, or may additionally retain the address of the last mapping block of the linked list, for faster execution.

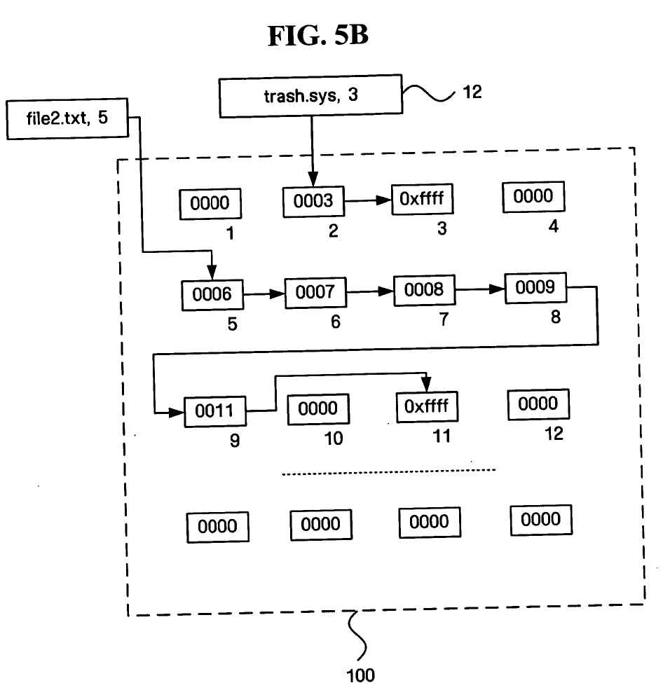

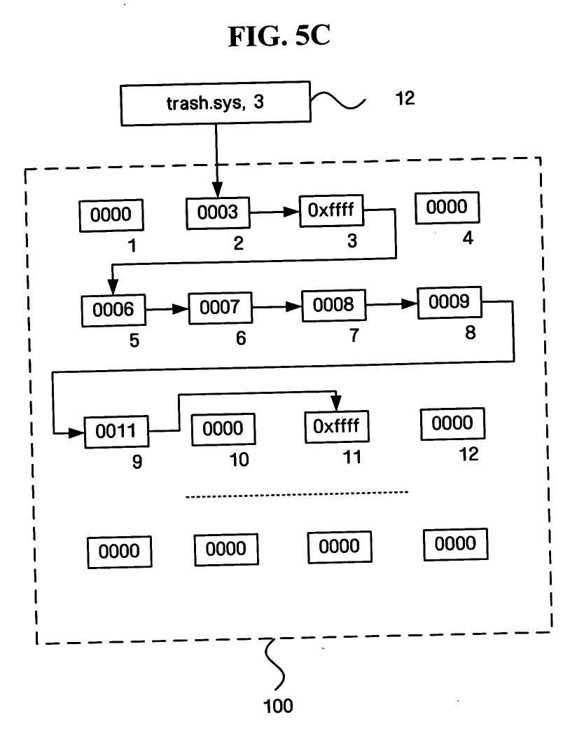

FIGS. 5A to 5C are conceptual diagrams illustrating an example of file deletion according to an exemplary embodiment of the present invention.

FIG. 5A shows two files named file1.txt and file2.txt. In this figure, a deletion list is embodied in the form of a file named trash.sys. This is an example of this embodiment, and may be constructed with a specific value as designated. That is, a mechanism to fixedly indicate a specific address within the file system and indicate a list of deleted mapping blocks based on the address may be used.

In FIG. 5A, a file of trash.sys has the value of 0xffff, indicating that there is no mapping block of a file previously deleted or a mapping block of the deleted file is reused so as to store data of a different file again. Naturally, this value can be differently defined according to particular file systems.

Through mapping of mapping blocks in the block map, it may be ascertained that file1.txt has two data blocks (2->3) and file2.txt has six data blocks (5->6->7->8->9->11). To delete a file, a first mapping block of the file to be deleted is linked to trash.sys 12. Where the value of 0xffff is stored in the deletion list, this linking may be changed to a start position of the file to be deleted since there is no mapped block because it has been deleted.

Since trash.sys as the deletion list does not indicate any special mapping block in FIG. 5A, deletion of file1.txt is completed by transferring the value of 2, which refers to a start mapping block of file1.txt, to the deletion list.

FIG. 5B illustrates a result that file1.txt is deleted from FIG. 5A. trash.sys as the deletion list indicates the mapping blocks of file1.txt deleted.

Where file2.txt is deleted after file1.txt has been deleted, a start address of file2.txt becomes the value of the last blockmap(3) of trash.sys as the deletion list. If so, trash.sys is linked to file2.txt. A result of this process is shown in FIG. 5C.

In FIG. 5C, the mapping block is changed but the data block need not be changed. This is because, although some data remain in the data block, they are garbage, and a different file can be stored by inputting a new value into this data block.

Thereafter, the block allocating unit may use a data block having the value of 0 of the mapping block or allocate the data block indicated by the mapping block in the deletion list.

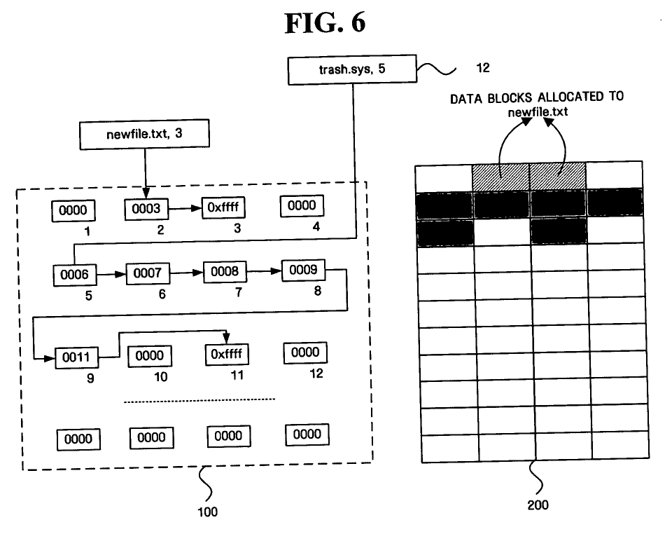

FIG. 6 is a conceptual diagram illustrating an operation by a block allocating unit to store a file according to an exemplary embodiment of the present invention.

FIG. 6 shows a result of a new file being added to the situation of the block map of FIG. 5C. The block allocating unit can locate a space whose mapping block value is 0 in the block map, according to a conventional method. In addition, a storage space may be allocated through the deletion list according to an exemplary embodiment of the present invention. The new file newfile.txt requires two data blocks. The data blocks addressed #2 and #3 can be fetched from the linked list indicated by the deletion list and then used. Since the mapping blocks addressed #2 and #3 are allocated to newfile.txt, trash.sys as the deletion list indicates the address of #5 next to these mapping blocks.

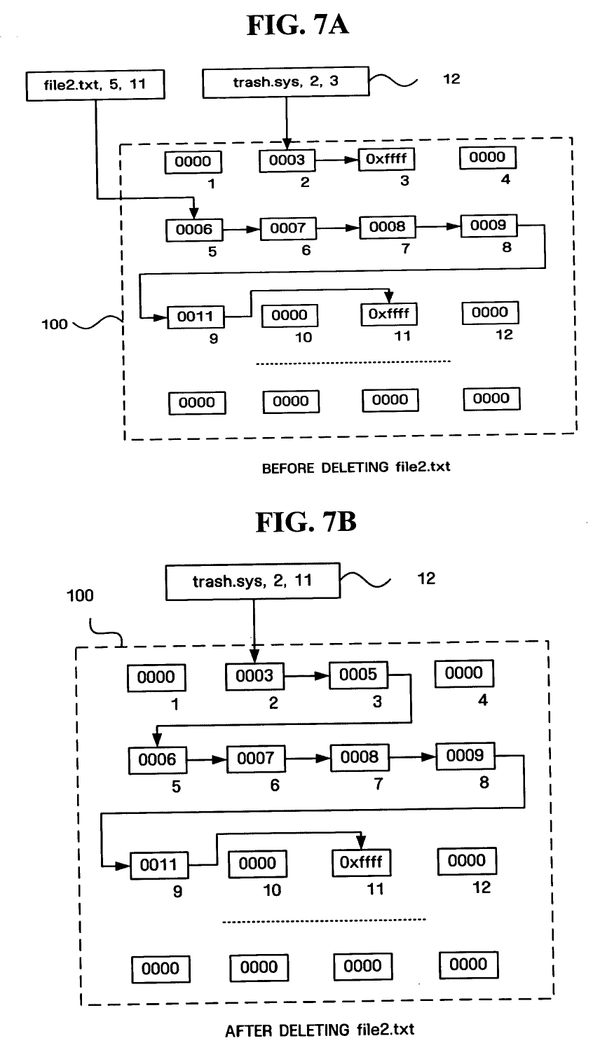

FIGS. 7A and 7B are block diagrams illustrating an example of file deletion according to another exemplary embodiment of the present invention.

In the case of a file having a large capacity, to find the mapping block indicating the termination of the file requires time for following the link sequentially. Naturally, the time taken to locate a value of the last mapping block following the link of the mapping block is shorter than the time taken to change the value to 0 while following the link of the mapping block.

The file system of FIGS. 7A and 7B also maintains the position of the last mapping block in addition to the position of the start mapping block, so as to shorten the time consumed in locating the link sequentially. The file file2.txt has values of the addresses #5 and #11 so as to ascertain this file. The address value #5 refers to the start position of the data storing file2.txt therein and #11 refers to the last position of the data storing file2.txt therein. The file trash.sys as the deletion list also has two values: #2 as the start position of the link and #3 as the last position of the link. FIG. 7A illustrates a structure of the block map before file2.txt is deleted. FIG. 7B illustrates a structure of the block map after file2.txt is deleted.

If file2.txt is deleted, the start position of file2.txt can be added to the end of the link of trash.sys as depicted in FIG. 5C. Without locating the end of the link by following the link of trash.sys, the last block may be ascertained through information of #3 in trash.sys. Thereafter, the start value of file2.txt, #5, is stored as the value of blockmap(3), and the value of the last mapping block of trash.sys is changed to the address of the last mapping block of file2.txt, #11. Even when deleting another file, the information that the last position of trash.sys is #11 may be easily ascertained without following the link.

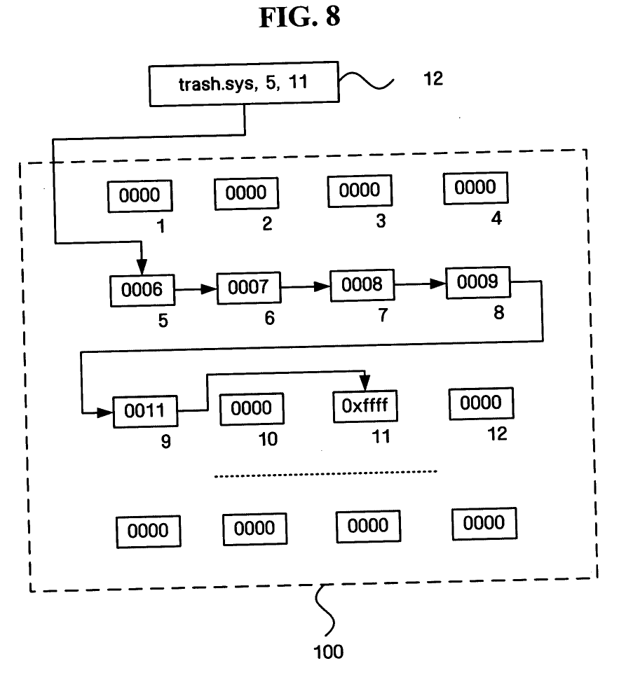

FIG. 8 is a block diagram illustrating restoration of a list of deleted files to an available storage space according to an exemplary embodiment of the present invention.

Advantageously, the deletion list makes it easy to delete a file. However, where a deletion list exists in detachable storage devices (e.g., an SD card, an MMC card), which can also be attached to other systems, the other systems will allocate blocks without considering this situation. Thus, it is desirable to remove the deletion list in those devices. For this purpose, there is needed an operation to restore a value of the mapping block constituting the deletion list to 0.

FIG. 8 illustrates that, with respect to a block map of FIGS. 7A and 7B, mapping blocks of the deletion list have been changed to 0 by the block allocating unit at regular intervals: the second and the third addresses of the mapping blocks both have the value of 0. However, where the deletion list has so many mapping blocks, it takes a long time to change all of them to 0. Thus, only some of the mapping blocks may be changed to 0. Further, where a system has been idle for a long period of time, all mapping blocks of the deletion list may be changed. The time taken for the block allocating unit to change the mapping blocks of the deletion list and the number of mapping blocks to be changed may be set up differently depending upon the resources and conditions of the system.

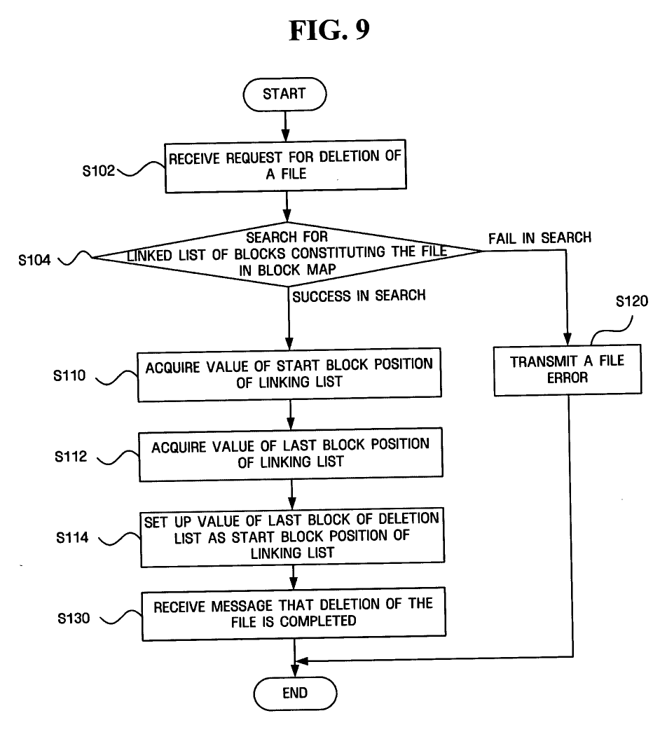

FIG. 9 is a flow chart illustrating deletion of a file according to an exemplary embodiment of the present invention.

The file system receives a request to delete a file from an application (S102). The application may be an operation system or a program used by a user. The file system having received the request searches for mapping blocks constituting the file in the block map (S104). The file system transmits an error in the file and terminates if it fails to locate the mapping blocks (S120). If the mapping blocks constituting the file are located as a result of the search, the file system obtains the position of the start mapping block of the file (S110). The file system obtains the position of the last mapping block of the deletion list (S112). If the value of the last mapping block of the deletion list is set up as an address of the start mapping block of the file to be deleted (S114), mapping blocks of the file to be deleted in the deletion list are logically connected in the format of a link. By doing so, the file is deleted and a message that file deletion has been completed is transmitted (S130).

The flow chart of FIG. 9 also illustrates addition of mapping blocks of the deleted file to the latter part of the deletion list. According to another exemplary embodiment, mapping blocks of the deleted file may be added to the latter part of the deletion list. This addition may be embodied diversely according to particular file systems.

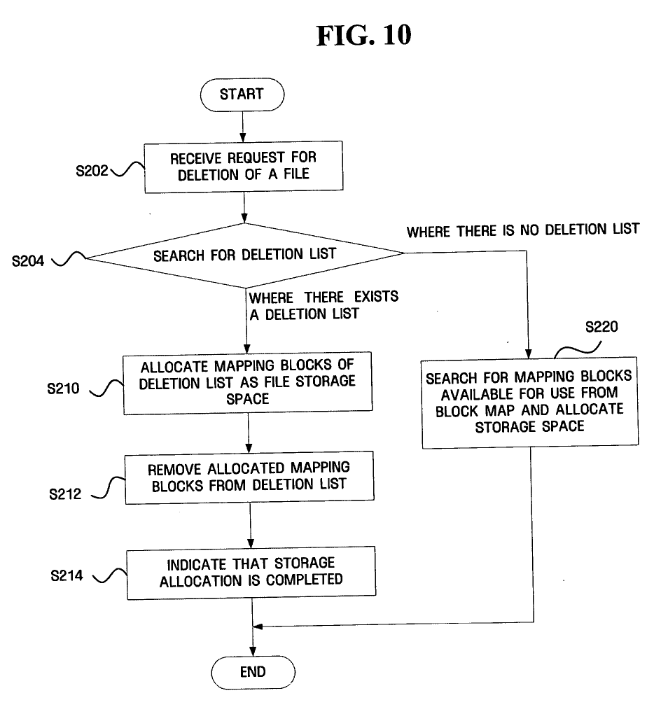

FIG. 10 is a flow chart illustrating storage of a file according to an exemplary embodiment of the present invention.

The file system receives a request to store a file from an application (S202). The application may be an operation system or a program used by a user. The file system having received the request searches for a deletion list in the block map (S204). Where there is no deletion list, the file system searches for mapping blocks available for use in the block map whereby a storage space may be allocated (S220).

Where there is a deletion list, the mapping blocks constituting the deletion list are allocated as a file storage space (S210). As an example of this allocation, the mapping blocks required for storing the file, among the mapping blocks constituting the deletion list, are returned to a linked list, through which the files are stored sequentially. Where there are no sufficient mapping blocks to store the file in the deletion list, the mapping blocks are restored so as to store a part of the file. Available mapping blocks are searched for in the remaining blocks in Operation S220, and as a result, the file storage may be allocated.

When the file storage is allocated, the mapping blocks can no longer constitute the deletion list, and thus, they are removed from the deletion list (S212). According to an exemplary embodiment wherein the deletion list is constituted with the form of a link, the link with respect to mapping blocks to be deleted is removed, and the mapping blocks allocated for the file storage are removed from the mapping blocks among the mapping blocks having constituted the previous deletion list so as to construct a link.

After removing the mapping blocks allocated for the file storage from the deletion list, the file system indicates that a space for storing the file therein is secured (S214). Following this, the file can be stored in the allocated space.

As described above, a file can be deleted and stored rapidly according to exemplary embodiments of the present invention.

Further according to exemplary embodiments of the present invention, the number of operations conducted for deletion and storage of the file can be reduced.

It will be understood by those of ordinary skill in the art that various changes in form and details may be made therein without departing from the spirit and scope of the present invention as defined by the following claims. Therefore, it is to be appreciated that the above described exemplary embodiments are for purposes of illustration only and not to be construed as a limitation of the invention. The scope of the invention is given by the appended claims, rather than the preceding description, and all variations and equivalents which fall within the range of the claims are intended to be embraced therein.

What is claimed is:

1. A method for efficient data management of a file, the method comprising:
receiving a request to delete a file;
searching for mapping blocks constituting the file in a block map which is constructed with a set of the mapping blocks, and the mapping blocks storing therein information about data blocks constituting the file; and
adding a linked list to a deletion list, wherein the linked list is formed with mapping blocks obtained as a result of the searching.

2. The method of claim 1, wherein the mapping blocks contain information about the data blocks in which data of the file are stored.

3. The method of claim 1, wherein the deletion list refers to a linked list of mapping blocks within the block map, the linked list of mapping blocks constituting a previously deleted file.

4. The method of claim 1, wherein a first mapping block constituting the linked list is added to a latter part of a last mapping block constituting the deletion list.

5. The method of claim 1, wherein a last mapping block constituting the linked list is added to a former part of a first mapping block constituting the deletion list.

6. The method of claim 1, further comprising removing information of mapping blocks constituting the deletion list from the deletion list, by indicating that it is available for use.

7. A method for efficient data management of a file, the method comprising:
receiving a request to allocate file storage space;
securing a storage space, using mapping blocks constituting a deletion list in a block map storing therein information about data blocks constituting the file; and
removing mapping blocks used for the storage space from the mapping blocks constituting the deletion list.

8. The method of claim 7, wherein the deletion list refers to a linked list of mapping blocks within the block map, the linked list of mapping blocks constituting a previously deleted file.

9. The method of claim 7, wherein the file is stored in data blocks indicated by the mapping blocks used in securing the storage space.

10. An apparatus for efficient data management of a file, the apparatus comprising:
data blocks in which data of the file are stored;
a block map which includes a set of mapping blocks storing therein information about the data blocks;
a deletion list which includes a set of mapping blocks constituting a previously deleted file; and
a block allocating unit which allocates a space for storing the file, using mapping blocks of the deletion list.

11. The apparatus of claim 10, wherein the mapping blocks contain information about blocks in which data of the file are stored.

12. The apparatus of claim 10, wherein the deletion list refers to a linked list of mapping blocks within the block map, the linked list of mapping blocks referring to mapping blocks constituting the file previously deleted.

13. The apparatus of claim 10, wherein a first mapping block constituting a linked list of the previously deleted file is added to a latter part of a last mapping block constituting the deletion list.

14. The apparatus of claim 10, wherein a last mapping block constituting a linked list of the previously deleted file is added to a former part of a first mapping block constituting the deletion list.

15. The apparatus of claim 10, wherein the block allocating unit receives a request for allocation of a file storage space, secures the file storage space using mapping blocks constituting the deletion list, and removes the mapping blocks used in the storing space from the deletion list.

16. The apparatus of claim 10, wherein the block allocating unit removes mapping blocks constituting the deletion list by indicating that they are available for use.

17. The apparatus of claim 10, wherein the file is stored in data blocks indicated by the data blocks as the storage space is allocated.
